(19) United States
(12) Patent Application Publication
(10) Pub. No.: US 2016/0184983 A1
(43) Pub. Date: Jun. 30, 2016

(54) POWER TOOL WITH FLYWHEEL AND GEAR FOR ACCELERATING SAID FLYWHEEL

(71) Applicant: ATLAS COPCO INDUSTRIAL TECHNIQUE AB, Stockholm (SE)

(72) Inventor: Robin MCGOUGAN, Enskede (SE)

(73) Assignee: ATLAS COPCO INDUSTRIAL TECHNIQUE AB, Stockholm (SE)

(21) Appl. No.: 14/910,818

(22) PCT Filed: Jun. 19, 2014
(86) PCT No.: PCT/EP2014/062910

§ 371 Date: Feb. 8, 2016

(30) Foreign Application Priority Data
Aug. 8, 2013 (SE) 1350944-3

(51) Int. Cl. B25F 5/00; B25B 21/00

(52) U.S. Cl. CPC B25F 5/001; B25B 21/00

(57) ABSTRACT

A hand held power tool, for delivering a torque to a joint, includes a housing, a motor, an output shaft, and a flywheel which is arranged in bearings with respect to the housing. A selection gear is arranged to selectively connect the motor to either the output shaft, or the flywheel, such that the flywheel may be set to rotate before a tightening operation and wherein the rotation of the flywheel may be used to decrease the counter forces acting on the power tool.

The invention relates to a hand held power tool for delivering a torque to tighten joints. Specifically, the invention relates to a hand held power tool with a flywheel, which is adapted to reduce the reaction forces sensed by an operator holding the tool, and which may be accelerated by means of the power tool motor.

### BACKGROUND

Hand held power tools are used in many different applications to deliver a torque to e.g. a joint. In many of these applications it is desirable that a specific, high torque may be delivered and that said torque may be delivered in an ergonomic manner for the operator holding the power tool. Specifically, the reaction forces acting on the tool should be sufficiently low such that the operator may handle the tool throughout the operation. In sophisticated power tools a tightening strategy is adapted so as to minimise the reaction forces.

In other power tools a flywheel is adapted to either deliver a torque to a joint or to reduce the counter forces experienced by an operator during a tightening operation. In most of these conventional power tools the flywheel is accelerated before a tightening operation is performed. Normally the flywheel is accelerated by means of an especially dedicated motor, internally or externally of the tool housing.

In U.S. Pat. No. 7,311,027 one motor is arranged to drive an output shaft and a second motor is arranged to drive a flywheel. During operation the flywheel will be retarded so as to produce a counter force to the forces produced in the joint an so as to reduce the reaction forces experienced by the examiner.

In U.S. Pat. No. 5,158,354 a flywheel is accelerated by a motor of the power tool whereby kinetic energy is transferred from the flywheel to the output shaft as an impulse without the creation of any reaction forces that need to be counteracted by the operator.

Both these arrangements reduce the reaction forces that need to be counter acted by the operator. They do however present relatively complicated arrangements. Therefore, there is a need of finding an arrangement that is simple, but that still allows the use of a flywheel to minimise the reaction forces that need to be counteracted by the operator.

### SUMMARY OF THE INVENTION

An object of the invention is to provide a power tool in which the reaction forces that will be transmitted to the operator will be kept as low as possible. This object is achieved by the invention according to claim 1.

The invention relates to a hand held power tool for delivering a torque to a joint, which power tool comprises a housing, a motor, an output shaft, and a flywheel, which is arranged in bearings with respect to the housing. A selection gear is arranged to selectively connect the motor to either the output shaft, or the flywheel, such that the flywheel may be set to rotate before a tightening operation and wherein the rotation of the flywheel may be used to drive the output shaft and/or to decrease the counter forces acting on the power tool.

In a specific embodiment of the invention the selection gear is a gear pin that is axially translatable between a position in which it connects the motor to the output shaft, and a position in which it connects the motor to the flywheel.

In another embodiment of the invention a solenoid is arranged to control the position of the selection gear.

In yet another embodiment of the invention the selection gear may be positioned in three different positions, wherein in the third position the motor is not connected to either the output shaft or the flywheel.

In a specific embodiment of the invention the solenoid is arranged to control the position of the selection gear between two end positions, a first end position in which it connects the motor to the output shaft, and a second, opposite position in which it connects the motor to the flywheel, and wherein a block arrangement is arranged to block the selection gear in a third position between the two end positions in which the motor is not connected to either the output shaft or the flywheel.

The block arrangement may comprise radial pins that extend out of the selection gear, and wherein a circumferential track is provided in a surface surrounding the selection gear, into which the radial pins will be pushed by centrifugal forces extend when the selection gear rotates, and wherein the interaction between the radial pins and the track will keep the selection gear in the third position.

Further, the outer ends of the radial pins may have a rounded portion, wherein the track is so shallow that it only allows part of the rounded portion, such that the rounded portion of the radial pins will interact with the track and allow the radial pins to be drawn out of the track as a result of an axial force acting on the selection gear.

In a specific embodiment of the invention the flywheel is connectable to the output shaft so as to at least partly drive the rotation of said output shaft or to reduce the counter forces acting on said output shaft.

Specific embodiments and other advantages of the invention will be apparent from the detailed description.

### SHORT DESCRIPTION OF THE DRAWINGS

In the following detailed description reference is made to the accompanying drawings, of which:

FIG. 1 shows a view of a specific embodiment of the invention;

FIGS. 2-4 show views of section II of FIG. 1 in three different modes;

FIG. 5 shows a detailed view of the view shown in FIG. 3.

### DETAILED DESCRIPTION OF THE SHOWN EMBODIMENTS OF THE INVENTION

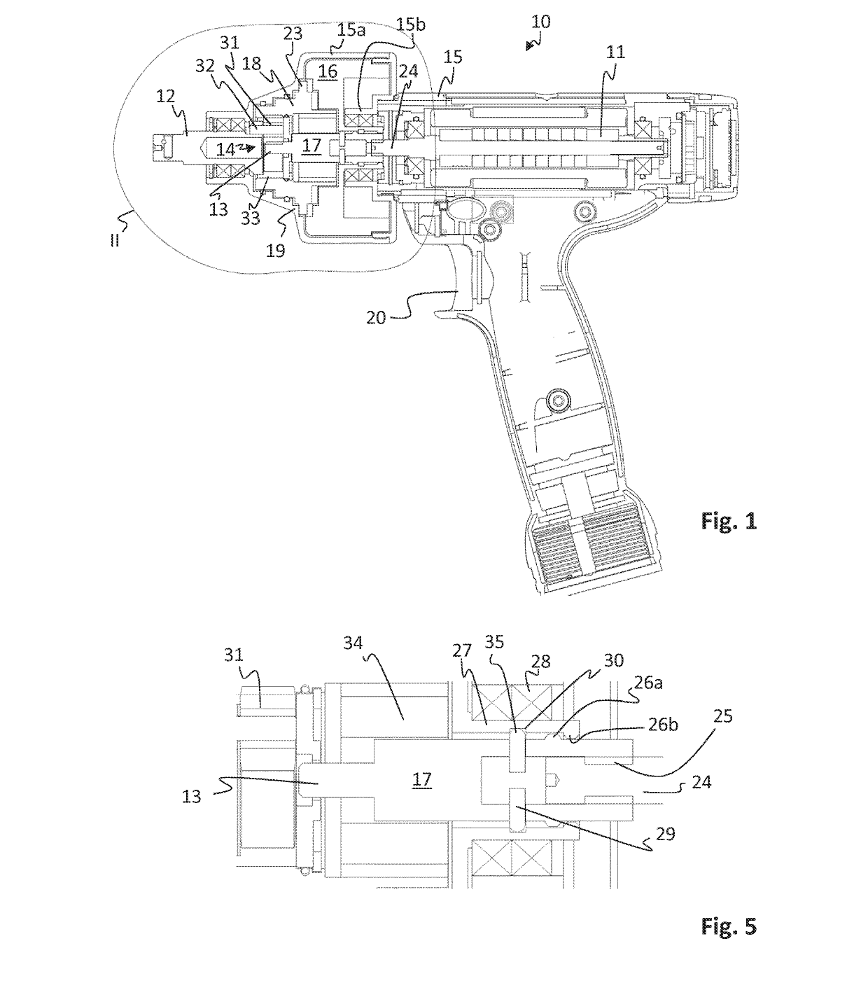

A specific embodiment of a power tool 10 according to the invention is shown in FIG. 1. The power tool 10 includes a housing 15 that comprises a front housing part 15a and an inner housing part 15b. A motor 11 is arranged inside said housing 15 to drive an output shaft 12 that extends out of the front housing part 15a. The power tool 10 further includes a flywheel 16, which is arranged in bearings 18 with respect to the inner housing part 15b, and a selection gear 17. The selection gear 17 is arranged to connect the motor 11 to either the output shaft 12 or the flywheel 16.

In the inventive embodiment shown in FIG. 1 the selection gear 17 is an axially translatable gear pin that is driven by a motor shaft 24 at a first end and that is connected to a planetary gear 14 in the opposite end. The motor shaft 24 is connected to and driven by a rotor of the motor 11. The front end of the selection gear 17 is constituted by an input shaft 13 that is connectable to the output shaft 12 via the planetary gear 14.

As illustrated in FIG. 1 the input shaft 13 constitutes a sun wheel of the planetary gear 14 when connected thereto. The sun wheel drives the planet wheels 31, which are interconnected by a planet wheel carrier 32. The planet wheel carrier 32 is connected to the output shaft 12. Hence, when the sun wheel is driven to rotate clockwise the planet wheels 31 will rotate counter clockwise around their own axes whereby the planet wheel carrier 32 rotates clockwise at a lower speed than the sun wheel.

In the shown embodiment the outer gear rim 33 is connected to a cam block 18 that is rotatably arranged inside the front housing part 15a. The cam block 18 includes at least one cam follower 23 in the form of a pin, which is arranged to interact with a cam profile 19 in the interior of the front housing part 15a. During a clockwise tightening operation the gear rim 33 and the cam block 18 will start to rotate counter clockwise as a result of counterforces produced in the joint that is being tightened and that acts on the output shaft 12. The rotation of the cam block 18 will bring it axially backwards following the cam profile 19, such that it will come into contact with the flywheel 16. The idea of the shown embodiment is that the reaction forces will be taken up by the flywheel 16, which will transfer kinetic energy to the cam block 18 when contact is made there between. Hereby, the cam block will be rotated clockwise, wherein the interaction between the cam follower 23 and the cam profile 19. In order for this to function the flywheel 16 will need to be set to rotate before a tightening operation is performed.

In another embodiment of the invention the flywheel 16 is connectable to the output shaft 12 and arranged to provide kinetic energy to it when needed, i.e. when the torque delivered by the motor 11 is not enough. The idea is that the motor 11 and the flywheel 16 will provide a sufficient torque jointly. When the joint may be tightened at a low torque a sufficient torque may be achieved by the motor 11 alone, without the production of any substantial counterforces. If the torque needed increases the supplementary torque may be delivered by the flywheel 16 to the output shaft 12.

In a first step of operation the flywheel 16 is set to rotate in the same direction as the output shaft 12 is to be rotated. Hence, when a conventional joint is to be tightened the flywheel 16 is set to rotate clockwise. The gear rim 33 and the cam block 18 will not rotate for as long as the counterforces acting on the output shaft 12 are below a certain threshold torque T_{Threshold}.

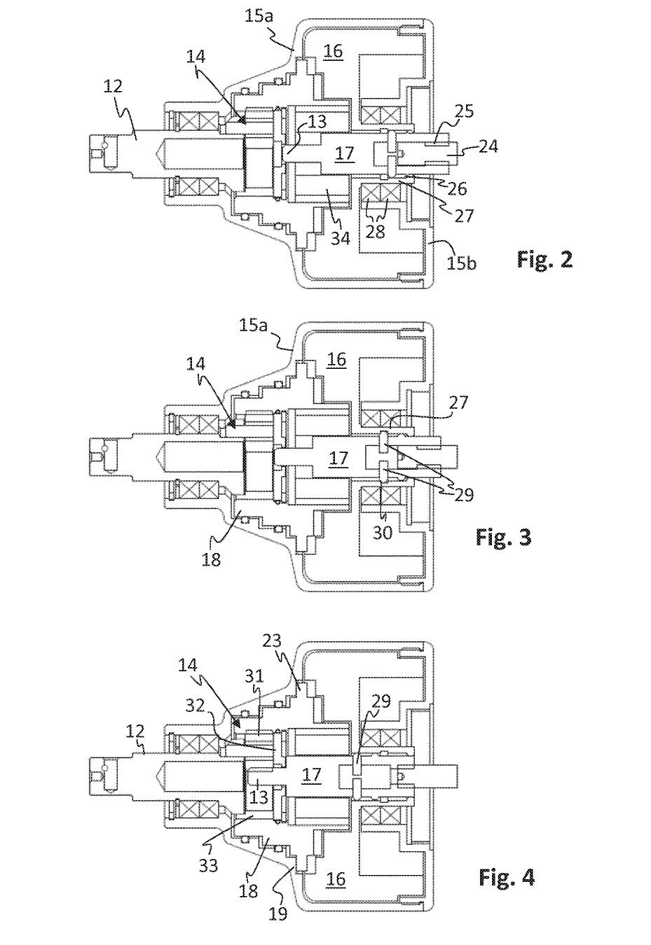

The invention particularly relates to the driving/acceleration of the flywheel and the output shaft, respectively. The function of an embodiment of the invention will be explained below, with reference to FIGS. 2-4, in which a detailed view of the front part of the tool 10 of FIG. 1 is shown in three different modes.

In FIG. 2 the tool is shown in a flywheel accelerating mode, in FIG. 3 the tool is shown in an intermediate mode, and in FIG. 4 the tool is shown in an operation mode. In the different modes the selection gear 17 is positioned in different positions. Hence, each mode corresponds to one specific position.

In the flywheel accelerating mode shown in FIG. 2 the selection gear 17 is positioned in a first position in which it connects the motor shaft 24 to the flywheel 16. The flywheel accelerating mode is used as a first step of a tightening operation in order to make sure that the flywheel 16 is rotating before a joint is tightened. The motor shaft 24 is connected to the selection gear 17 via a splined coupling 25 that allows the selection gear 17 to be axially translated with respect to the tool housing 15. The selection gear 17 is connected via splines 26 to an inner portion 27 of the flywheel 16. The flywheel 16 is carried in bearings 28 with respect to the inner housing part 15b. The front part of the selection gear 17 that forms the input shaft 13 is not in gear with the planetary gear 14.

The selection gear 17 is such arranged that it may be axially translated and its position may be controlled by means of a solenoid 34. In the shown embodiment the solenoid 34 is of the type that may be adjustable between two positions. It may however also be a solenoid of the type that may be adjustable between three positions. Instead of a solenoid another type of gear controlling mechanism may be used, e.g. a mechanism including a spring arrangement.

When the flywheel 16 has been accelerated by the motor 11 to a desired rotational speed the selection gear 17 is axially translated to the intermediate mode, shown in FIG. 3. In the intermediate mode the selection gear 17 is not in gearing contact with either the inner portion 27 of the flywheel 16 or the planetary gear 14. In order to move the selection gear 17 from out of its splined connection 26 to the flywheel 16 the solenoid 34 is re-positioned so as to translate the selection gear 17 towards its second end position where it is in contact with the planetary gear 14. The selection gear 17 will however be halted in a third, intermediate position before it reaches said end position.

Namely, the selection gear 17 comprises a blocking arrangement 29,30 that will obstruct the selection gear 17 from a complete translation. The blocking arrangement comprises radial pins 29, which extend radially from the surface of the selection gear 17 when it rotates at a rotational speed above a certain rpm. When the selection gear 17 is axially translated from the interaction with the flywheel 16 it rotates at the same rpm as the flywheel 16 such that the radial pins 29 will extend out of their respective holes in the selection gear 17 and into contact with the surrounding surface of the inner portion 27 of the flywheel 16. As the selection gear 17 is axially translated from the interaction with the flywheel 16 the radial pins 29 will extend into a circumferential track 30 along the surface of the inner portion 27 of the flywheel 16. The interaction between the radial pins 29 and the track 30 will obstruct the selection gear 17 from further axial translation until the rotational speed of the selection gear 17 reaches below a threshold speed at which the radial pins 29 will be retracted into the selection gear 17 and out of the track 30, such that the selection gear 17 may be dislocated from the position corresponding to the intermediate mode.

In the intermediate mode the selection gear 17 is positioned in a third position not in gear with either the flywheel 16 or the output shaft 12, but can rotate freely with respect housing 15. It will however still be connected to the motor 11 and may therefore be retarded very quickly by adding a braking current to the motor. The selection gear 17 should not be rotating when it is re-positioned into gearing contact with the output shaft 12.

As is visible in FIG. 5, which is a detailed view of FIG. 3, an outer spline 26a on the selection gear 17 is out of contact with a corresponding inner spline 26b on the inside of the inner portion 27 of the flywheel 16 when the selection gear 17 is in the intermediate mode.

As explained above the selection gear 17 is kept in a third position corresponding to the intermediate mode by means of a block arrangement comprising radial pins 29 that extend into a circumferential track 30 is a surface surrounding the selection gear 17, i.e. the inner surface of the inner portion 27 of the flywheel 16. The radial pins 29 are pushed by centrifugal forces into this track 30 when the selection gear 17 rotates. The interaction between the radial pins 29 and the circumferential track 30 will keep the selection gear 17 in the third position for as long as the selection gear 17 rotates at a rotational speed that exceeds a certain threshold speed.

The outer ends of the radial pins 29 have a rounded portion 35, wherein the track 30 is so shallow that it only allows part of the rounded portion 35, such that the rounded portion 35 of the radial pins 29 will interact with the track 30 and allow the radial pins to be drawn out of the track 30 as a result of an axial force acting on the selection gear 17. This means that the interaction between the radial pins 29 and the track 30 will be dependent of the rotational speed of the selection gear 17. As soon as the rotational speed reaches below the threshold speed the action of the solenoid will be sufficient to release the interaction between the radial pins 29 and the track 30 and bring the selection gear 17 towards the operation mode.

In the operation mode the selection gear 17 connects the motor 11 to the output shaft 12, via the planetary gear 14, such that the output shaft 12 may be accelerated by means of the motor 11. In FIG. 4 the selection gear 17 is shown in the operation mode. In this mode the input shaft 13 acts as the sun wheel of the planetary gear 14. The input shaft 13 will hence drive the rotation of a number of planet wheels 31. In practice only one planet wheel is needed, but preferably at least three planet wheels are used. The planet wheels 31 are interconnected by means of a planet wheel carrier 32, which in turn is connected to the output shaft 12. A gear rim 33 is arranged in gearing connection with the planet wheels 31 outside said wheels.

As the sun wheel, i.e. the input shaft 13, is rotated clockwise the planet wheels 31 will be set to rotate counter clockwise around their own axes. The planet wheel carrier 32 will thereby be set to rotate clockwise at a rotational speed that is about 3-5 times lower than that of the input shaft 13. Due to the fact that the planet wheel carrier 32 is connected to the output shaft 12, the output shaft 12 will rotate at the same rotational speed as the planet wheel carrier 32.

The gear rim 33 is connected to the cam block 18. For as long as the output shaft 12 may be driven without substantially effort the gear rim 33 and the cam block 18 will not rotate. As soon as the counter forces acting on the output shaft 12 reaches over a specific threshold value, e.g. when a clamp force is produced a joint that is tightened, the gear rim 33 and the cam block 18 will be set to rotate counter clockwise. The interaction of the at least one cam follower 23 that follows the cam profile 19 will force the cam block 18 axially backwards towards the flywheel 16, which will provide a force that will act clockwise on the cam block 18.

The shown embodiment provides a function that implies that equilibrium may be found, in which so much energy that is needed in every instant is provided from the flywheel 16 to the cam block 18 and the interconnected gear rim 33.

The invention is intended for power tools with a flywheel that may be set to rotate. The precise arrangement and function of the flywheel may however be set up in many different ways. Above, the invention has been described with reference to a specific embodiment. The invention is however not limited to this embodiment. A skilled person will be able to find different alternatives to the different features of the specific embodiment, which lie within the scope of the invention. The invention is only limited by the following claims.

1-8. (canceled)

9. A hand held power tool for delivering a torque to a joint, the power tool comprising:
a housing,
a motor,
an output shaft, and
a flywheel arranged in bearings with respect to the housing,
wherein a selection gear is arranged to selectively connect the motor to either the output shaft or the flywheel.

10. The hand held power tool according to claim 9, wherein the selection gear is a gear pin that is axially translatable between a position in which it connects the motor to the output shaft, and a position in which it connects the motor to the flywheel.

11. The hand held power tool according to claim 10, wherein a solenoid is arranged to control the position of the selection gear.

12. The hand held power tool according to claim 10, wherein the selection gear may be positioned in three different positions, and wherein in the third position the motor is not connected to either the output shaft or the flywheel.

13. The hand held power tool according to claim 11, wherein the solenoid is arranged to control the position of the selection gear between two end positions, a first end position in which it connects the motor to the output shaft, and a second, opposite position in which it connects the motor to the flywheel, and wherein a block arrangement is arranged to block the selection gear in a third position between the two end positions in which the motor is not connected to either the output shaft or the flywheel.

14. The hand held power tool according to claim 13, wherein the block arrangement comprises a plurality of radial pins that extend out of the selection gear, and wherein a circumferential track is provided in a surface surrounding the selection gear, into which the plurality of radial pins will be pushed by centrifugal forces when the selection gear rotates, and wherein an interaction between the plurality of radial pins and the circumferential track will keep the selection gear in the third position.

15. The hand held power tool according to claim 14, wherein an outer end of each of the plurality of radial pins has a rounded portion and wherein the circumferential track is shallow such that only a part of the rounded portion of the outer end of each of the plurality of radial pins can interact with the circumferential track and the plurality of radial pins can be drawn out of the circumferential track as a result of an axial force acting on the selection gear.

16. The hand held power tool according to claim 9, wherein the flywheel is connectable to the output shaft so as to at least one of:
partly drive a rotation of the output shaft, and
reduce the counter forces acting on the output shaft.

17. The hand held power tool according to claim 11, wherein the selection gear may be positioned in three different positions, and wherein in the third position the motor is not connected to either the output shaft or the flywheel.

18. The hand held power tool according to claim 10, wherein the flywheel is connectable to the output shaft so as to at least one of:
partly drive a rotation of the output shaft, and
reduce the counter forces acting on the output shaft.

19. The hand held power tool according to claim 11, wherein the flywheel is connectable to the output shaft so as to at least one of:
partly drive a rotation of the output shaft, and
reduce the counter forces acting on the output shaft.

20. The hand held power tool according to claim 12, wherein the flywheel is connectable to the output shaft so as to at least one of:
partly drive a rotation of the output shaft, and
reduce the counter forces acting on the output shaft.

21. The hand held power tool according to claim 13, wherein the flywheel is connectable to the output shaft so as to at least one of:
partly drive a rotation of the output shaft, and
reduce the counter forces acting on the output shaft.

22. The hand held power tool according to claim 14, wherein the flywheel is connectable to the output shaft so as to at least one of:
partly drive a rotation of the output shaft, and
reduce the counter forces acting on the output shaft.

23. The hand held power tool according to claim 15, wherein the flywheel is connectable to the output shaft so as to at least one of:
partly drive a rotation of the output shaft, and
reduce the counter forces acting on the output shaft.

24. The hand held power tool according to claim 17, wherein the flywheel is connectable to the output shaft so as to at least one of:
partly drive a rotation of the output shaft, and
reduce the counter forces acting on the output shaft.
